(19) United States
(12) Patent Application Publication
(10) Pub. No.: US 2022/0101337 A1
(43) Pub. Date: Mar. 31, 2022

(54) COMPLIANCE DETERMINATION DEVICE, AND METHOD THEREFOR

(71) Applicant: Nippon Telegraph and Telephone Corporation, Tokyo (JP)

(72) Inventor: Kenichi Kashibuchi, Musashino-shi, Tokyo (JP)

(21) Appl. No.: 17/423,055

(22) PCT Filed: Jan. 15, 2020
(86) PCT No.: PCT/JP2020/000937

§ 371 Date: Jul. 14, 2021

(30) Foreign Application Priority Data
Jan. 29, 2019 (JP) 2019-012682

(51) Int. Cl. G06Q 30/00; G06N 20/00

(52) U.S. Cl. CPC G06Q 30/018; G06N 20/00

(57) ABSTRACT

A compliance determination apparatus capable of determining compliance with a design guideline without preparing a fixed determination rule in advance is provided. A compliance determination apparatus includes an API specification storage unit 10 configured to store an application programming interface specification complying with a convention illustrated in a design guideline, a training data extraction unit 20 configured to extract training data of a set of a character string describing each item of the application programming interface specification and a label corresponding to the character string, an identification function generation unit 30 configured to acquire the training data and generate, by machine learning, an identification function of determining whether each item of API specification information input from an outside complies with the design guideline, and a compliance determination unit 40 configured to extract test data of a corresponding set of the character string and the label from the API specification information for each item of the design guideline and determine whether the test data complies with the design guideline by inputting the test data into the identification function.

### TECHNICAL FIELD

The present disclosure relates to a technology for determining whether a design specification document complies with a rule.

### BACKGROUND ART

In recent years, various network services have been provided in a form of an application programming interface (hereinafter, the API). For example, the API is a structure for using information and functions of another system through data exchange.

Thus, in a case of building a new network service, from the viewpoint of facilitating use of the API, an API specification is desirably designed based on a statistical principle (API design principle). Thus, it is necessary to determine whether each API specification complies with the design principle (hereinafter, the design guideline).

A tool (Non Patent Literature 1) for testing after API implementation has been known as a system for determining compliance with the design guideline.

### CITATION LIST

### Non Patent Literature

Non-Patent Literature 1: Postman Makes API Development Simple, Internet <URL: http://www.getpostman.com/>[searched on Jan. 16, 2019]

### SUMMARY OF THE INVENTION

### Technical Problem

In the technology disclosed in Non-Patent Literature 1, whether a certain value in the API specification is included in a convention illustrated in the design guideline can be determined. However, whether the value is used in a meaning illustrated in the design guideline cannot be determined. That is, it is not possible to deal with variations in expression of an API specification document. In short, a problem that accurate determination cannot be performed because of determination based on a fixed determination rule arises.

The present disclosure is conceived in view of such a problem, and an object of the present disclosure is to provide a compliance determination apparatus and a method capable of determining compliance with a design guideline without preparing a fixed determination rule in advance.

### Means for Solving the Problem

A compliance determination apparatus according to an aspect of the present disclosure includes an API specification storage unit configured to store an application programming interface specification complying with a convention illustrated in a design guideline, a training data extraction unit configured to extract training data of a set of a character string describing each item of the application programming interface specification and a label corresponding to the character string, an identification function generation unit configured to acquire the training data and generate, by machine learning, an identification function of determining whether each item of API specification information input from an outside complies with the design guideline, and a compliance determination unit configured to extract test data of a corresponding set of the character string and the label from the API specification information for each item of the design guideline and determine whether the test data complies with the design guideline by inputting the test data into the identification function.

A compliance determination method according to an aspect of the present disclosure is a compliance determination method executed by the compliance determination apparatus, the compliance determination method including extracting training data of a set of a character string describing each item of an application programming interface specification and a label corresponding to the character string, acquiring the training data and generating, by machine learning, an identification function of determining whether each item of API specification information input from an outside complies with the design guideline, and extracting test data of a corresponding set of the character string and the label from the API specification information for each item of the design guideline and determining whether the test data complies with the design guideline by inputting the test data into the identification function.

### Effects of the Invention

According to the present disclosure, a compliance determination apparatus and a method capable of determining compliance with a design guideline without preparing a fixed determination rule in advance can be provided.

### BRIEF DESCRIPTION OF DRAWINGS

FIG. 1 is a block diagram illustrating a functional configuration example of a compliance determination apparatus according to a first embodiment of the present disclosure.

FIG. 2 is a flowchart illustrating a summarized processing procedure of the compliance determination apparatus illustrated in FIG. 1.

FIG. 3 is a diagram illustrating an example of a part of a specification of an application programming interface.

FIG. 4 is a diagram illustrating an example of a part of a specification of an application programming interface that does not comply with a design guideline.

FIG. 5 is a block diagram illustrating a functional configuration example of a compliance determination apparatus according to a second embodiment of the present disclosure.

FIG. 6 is a flowchart illustrating a summarized processing procedure of the compliance determination apparatus illustrated in FIG. 5.

FIG. 7 is a block diagram illustrating a functional configuration example of a compliance determination apparatus according to a third embodiment of the present disclosure.

FIG. 8 is a flowchart illustrating a summarized processing procedure of the compliance determination apparatus illustrated in FIG. 7.

FIG. 9 is a diagram illustrating an example of an application programming interface specification collected by an API information collection unit illustrated in FIG. 7.

### DESCRIPTION OF EMBODIMENTS

Hereinafter, an embodiment of the present disclosure will be described with reference to the accompanying drawings. The same components in a plurality of drawings are denoted by the same reference signs, and thus the detailed description thereof will not be repeated.

### First Embodiment

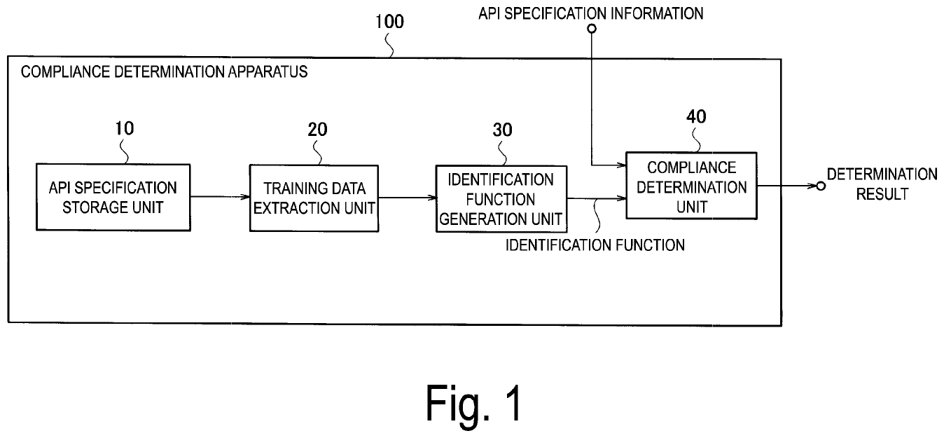

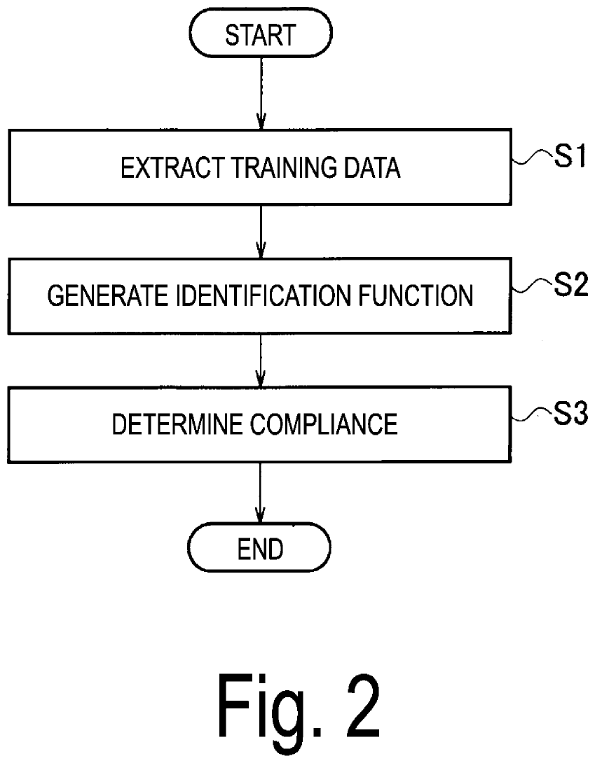

FIG. 1 is a block diagram illustrating a functional configuration example of a compliance determination apparatus according to a first embodiment of the present disclosure. FIG. 2 is a flowchart illustrating a summarized processing procedure of a compliance determination apparatus 100 illustrated in FIG. 1.

The compliance determination apparatus 100 includes an API specification storage unit 10, a training data extraction unit 20, an identification function generation unit 30, and a compliance determination unit 40. Cooperation between functional components is controlled by a control unit (not illustrated). Only functional components necessary for describing the present embodiment are illustrated in FIG. 1. General functional components such as an input unit, a storage unit, the control unit, and a display unit necessary for configuring the compliance determination apparatus 100 are not illustrated.

For example, the compliance determination apparatus 100 can be realized by a computer including a ROM, a RAM, and a CPU. When each functional component is realized by a computer, processing content of a function that each functional component should have is described by a program. The same applies to other embodiments described later.

The API specification storage unit 10 stores an application programming interface (hereinafter, abbreviated to the API) specification that complies with a convention illustrated in a design guideline. The design guideline is a so-called design principle and describes a definition such as a common data item in a case of exchanging data between servers.

The API specification storage unit 10 stores the design guideline in association with one or more API specification documents complying with the convention illustrated in the design guideline. The API specification documents may be a plurality of API specification documents within a scope of the same design guideline. The number of design guidelines is one.

One example of the design guideline line is “TMF630 API Design Guidelines 3.0 R17.5.1”, and one example of API specification information complying with the convention illustrated in the design guideline is “TMF629 Customer Management API REST Specification R18.0.0”.

The training data extraction unit 20 extracts training data of a set of a specific character string (for example, a summary field included in each convention in a Swagger file) related to each item of the design guideline in the API specification document and a label (for example, an HTTP method field) corresponding to the character string. For example, the extracted training data is stored in the RAM.

The training data extraction unit 20 extracts training data of a set of a character string describing each item of the API specification document and a label corresponding to the character string (FIG. 2: step S1). For example, one of each item of the API specification document is an “HTTP method” shown in Table 1. A status code that represents a result of execution of the API is also one of each item of the API specification document.

Table 1 shows a part of the HTTP method. In addition to the part shown in Table 1, for example, HEAD is also present but is not shown.

TABLE 1

| HTTP | USAGE (DESCRIBING WITH CHARACTER |
|---|---|
| METHOD | STRING) |
| GET | “READ” OF RESOURCE INFORMATION |
| POST | “CREATE” NEW RESOURCE INFORMATION |
| PUT | “UPDATE” OF RESOURCE INFORMATION |
| DELETE | “DELETION” OF RESOURCE INFORMATION |

For example, ““read” of resource information” in a second column of Table 1 is one character string describing a GET method. And, for example, “GET” in a first column of Table 1 is a label corresponding to the character string.

Thus, the training data extraction unit 20 extracts training data of a set of the character string ““read” of resource information” and the label “GET”. A set of a character string and a label is also extracted from the status code representing the result of execution of the API. For example, this character string is “normal response”. The label corresponding to the character string of the status code is “200”.

Table 2 shows a part of the status code.

TABLE 2

| STATUS | |
|---|---|
| CODE | USAGE (DESCRIBING WITH CHARACTER STRING) |
| 200 | NORMAL RESPONSE |
| 401 | NOT APPROVED |

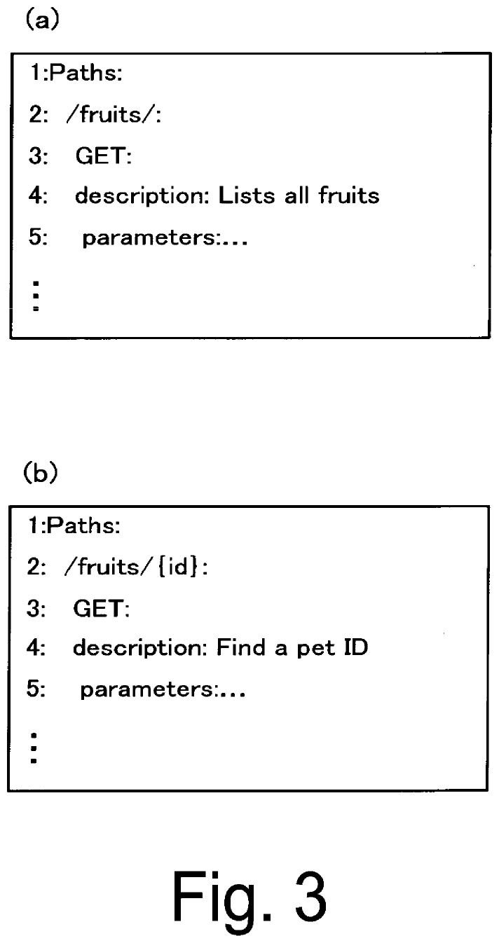

FIG. 3 is a diagram illustrating an example of the training data. The example illustrated in FIG. 3 illustrates an example in which there are two character strings of “List all fruits” (FIG. 3(a)) and “Find a pet ID” (FIG. 3(b)) that describe meanings of the API which uses the same HTTP method of a GET method. As illustrated, there may be variations in expression of the API specification.

The identification function generation unit 30 acquires the training data extracted by the training data extraction unit 20 and generates, by machine learning, an identification function of determining whether each item of the API specification information input from an outside complies with the design guideline (step S2). For example, the machine learning uses a well-known support vector machine. Machine learning based on a Naive Bayes method may also be performed.

The identification function generated by the machine learning determines whether the API specification information complies with the design guideline by inputting each item of the API specification information input from the outside.

The compliance determination unit 40 extracts test data of a corresponding set of a character string and a label for each item of the design guideline from the API specification information input from the outside and determines whether the test data complies with the design guideline by inputting the test data into the identification function (step S3).

In a case where the label “GET” and the character string “List all fruits” are present in the test data extracted from the API specification information input from the outside, the identification function generated from the training data illustrated in FIG. 3 determines that the items of the API specification information comply with the design guideline.

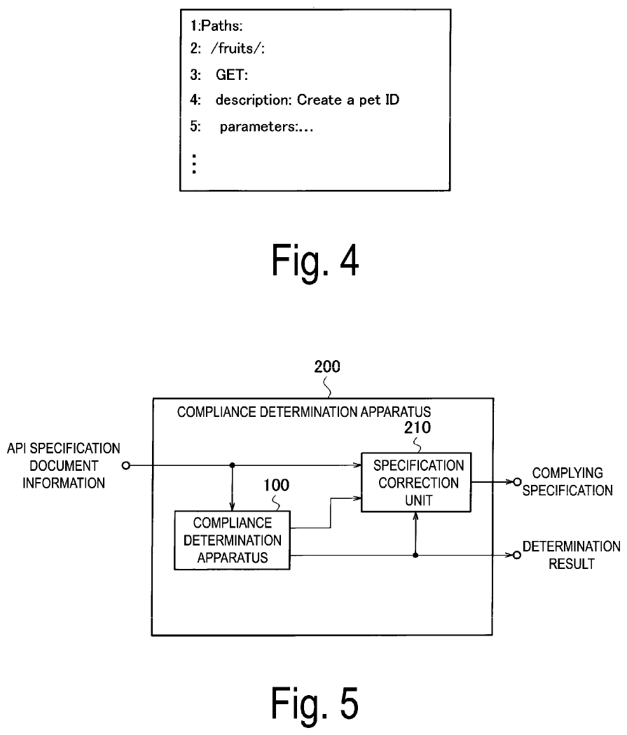

FIG. 4 is a diagram illustrating one example of API specification information that does not comply with the design guideline. As illustrated in FIG. 4, the GET method is described in a third row. However, a description in a fourth row describes “Create a pet ID”. From this description, it is considered that this API is an API for creating new resource information, and that a POST method is to be used as the HTTP method.

In such a case, the compliance determination unit 40 determines that test data including the label “GET” and a character string “Create a pet ID” does not comply with the design guideline. For example, a determination result is displayed on the display unit (not illustrated).

As described above, the compliance determination apparatus 100 according to the present embodiment includes the API specification storage unit 10, the training data extraction unit 20, the identification function generation unit 30, and the compliance determination unit 40. The API specification storage unit 10 stores the API specification complying with the convention illustrated in the design guideline. The training data extraction unit 20 extracts the training data of the set of the character string describing each item of the API specification and the label corresponding to the character string. The identification function generation unit 30 acquires the training data and generates, by the machine learning, the identification function of determining whether each item of the API specification information input from the outside complies with the design guideline. The compliance determination unit 40 extracts, from the API specification information input from the outside, the test data of the corresponding set of the character string and the label for each item of the design guideline and determines whether the test data complies with the design guideline by inputting the test data into the identification function. Thus, a compliance determination apparatus capable of determining compliance with a design guideline without preparing a fixed determination rule in advance can be provided.

### Second Embodiment

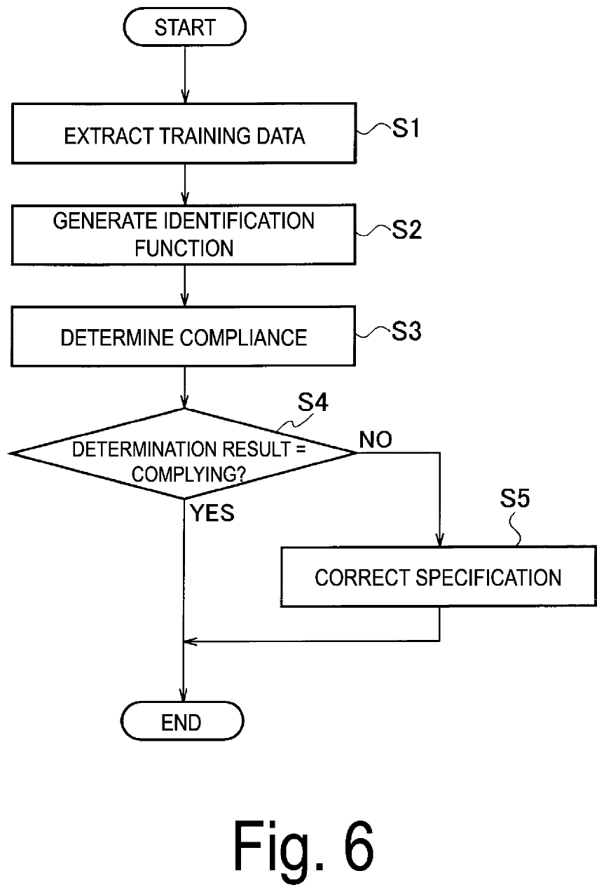

FIG. 5 is a block diagram illustrating a functional configuration example of a compliance determination apparatus according to a second embodiment of the present disclosure. FIG. 6 is a flowchart illustrating a summarized processing procedure of a compliance determination apparatus 200 illustrated in FIG. 5.

The compliance determination apparatus 200 is different from the compliance determination apparatus 100 (FIG. 1) in that the compliance determination apparatus 200 includes a specification correction unit 210. The specification correction unit 210 corrects the API specification information determined as not complying with the design guideline by the compliance determination apparatus 100 (NO in step 4) to a specification complying with the design guideline using the identification function (step S5).

The specification correction unit 210 corrects the “GET” HTTP method to the “POST” HTTP method corresponding to “Create a pet ID” of the description for the items of the API specification information illustrated in FIG. 4. In a case of using the identification function, a character string of the HTTP method corresponding to the API specification information can be generated.

As described, the compliance determination apparatus 200 according to the present embodiment includes the specification correction unit 210 that corrects the API specification information determined as not complying with the design guideline to the specification complying with the design guideline using the identification function. The API design specification information not complying with the design guideline is corrected to comply with the design guideline. Thus, convenience of a user can be improved.

### Third Embodiment

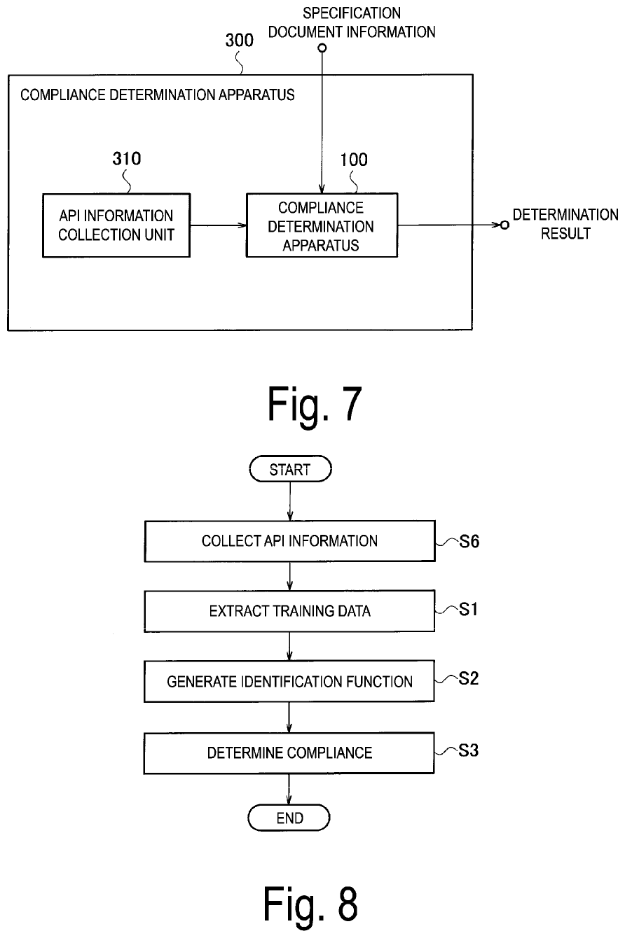

FIG. 7 is a block diagram illustrating a functional configuration example of a compliance determination apparatus according to a second embodiment of the present disclosure. FIG. 8 is a flowchart illustrating a summarized processing procedure of a compliance determination apparatus 300 illustrated in FIG. 7.

The compliance determination apparatus 300 is different from the compliance determination apparatus 100 (FIG. 1) and the compliance determination apparatus 200 (FIG. 5) in that the compliance determination apparatus 300 includes an API information collection unit 310. The API information collection unit 310 collects a plurality of API specifications complying with another design guideline having the same convention as each item of the design guideline from the outside through a network and outputs the plurality of API specifications to the training data extraction unit 20 (step S6).

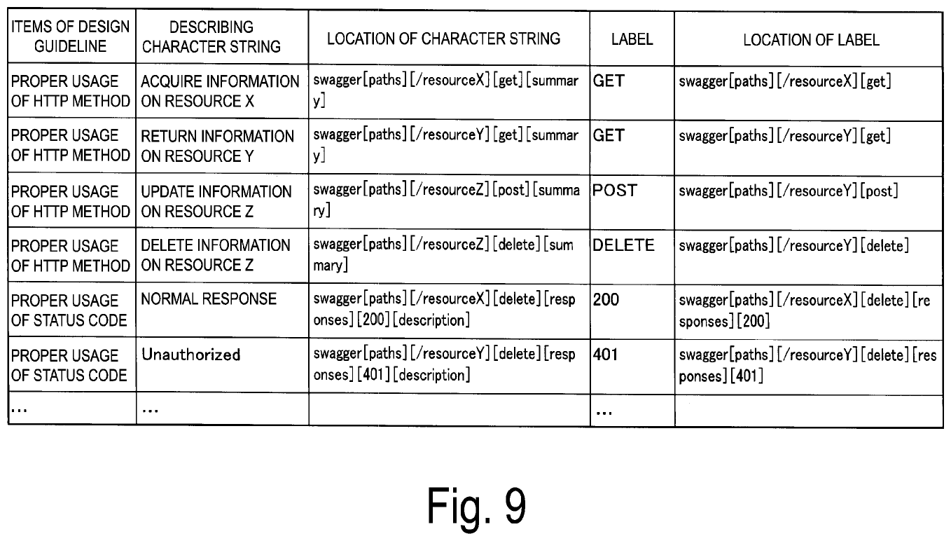

FIG. 9 is a diagram illustrating an example of the API specifications collected by the API information collection unit 310. From left of FIG. 9, “items of design guideline”, “describing character string”, “location of character string”, “label”, and “location of label” are present.

A set of “items of design guideline”, “describing character string”, and “label” illustrated in FIG. 9 constitutes the training data. Here, “location of character string” and “location of label” are information indicating a location at which each information is present in the API specification document, and may not be necessary.

The API information collection unit 310 collects the plurality of API specifications (Swagger files) that are in accordance with the other design guideline having the same convention, or information (for example, URIs) for identifying the API specifications for each item (for example, a proper usage standard of the HTTP method corresponding to a usage) of the design guideline as a compliance target. The information collected by the API information collection unit 310 is output to the training data extraction unit 20. Thus, the number of pieces of the training data can be increased.

As described, the compliance determination apparatus 300 according to the present embodiment collects the plurality of API specifications complying with the other design guideline having the same convention as each item of the design guideline from the outside through the network and outputs the plurality of API specifications to the training data extraction unit 20. Thus, the number of pieces of the training data can be increased, and accuracy of the identification function can be improved.

As described above, according to the compliance determination apparatuses 100, 200, and 300 according to the present embodiment, a compliance determination apparatus and a method capable of determining compliance with a design guideline without preparing a fixed determination rule in advance can be provided.

The compliance determination apparatus 300 (FIG. 7) is described as an example in which the compliance determination apparatus 100 (FIG. 1) includes the API information collection unit 310, but is not limited to such an example. The compliance determination apparatus 200 (FIG. 5) may be configured to include the API information collection unit 310.

It is a matter of course that various embodiments and the like that are not described herein are also included in the present disclosure. Thus, the technical scope of the present disclosure is defined only by the subject matters according to the claims that are appropriate from description above.

### REFERENCE SIGNS LIST

100, 200, 300: Compliance determination apparatus

10: API specification storage unit

20: Training data extraction unit

30: Identification function generation unit

40: Compliance determination unit

210: Specification correction unit

310: API information collection unit

1. A compliance determination apparatus comprising:
an API specification storage unit configured to store an application programming interface specification complying with a convention illustrated in a design guideline;
a training data extraction unit, including one or more processors, configured to extract training data of a set of a character string describing each item of the application programming interface specification and a label corresponding to the character string;
an identification function generation unit, including one or more processors, configured to acquire the training data and generate, by machine learning, an identification function of determining whether each item of API specification information input from an outside complies with the design guideline; and
a compliance determination unit, including one or more processors, configured to extract test data of a corresponding set of the character string and the label from the API specification information for each item of the design guideline and determine whether the test data complies with the design guideline by inputting the test data into the identification function.

2. The compliance determination apparatus according to claim 1, further comprising a specification correction unit, including one or more processors, configured to correct the API specification information determined as not complying with the design guideline to a specification complying with the design guideline using the identification function.

3. The compliance determination apparatus according to claim 1, further comprising an API information collection unit, including one or more processors, configured to collect a plurality of the application programming interface specifications complying with another design guideline having a convention identical to each item of the design guideline from the outside through a network and output the plurality of application programming interface specifications to the training data extraction unit.

4. A compliance determination method executed by a compliance determination apparatus including one or more processors, the compliance determination method comprising:
extracting training data of a set of a character string describing each item of an application programming interface specification and a label corresponding to the character string;
acquiring the training data and generating, by machine learning, an identification function of determining whether each item of API specification information input from an outside complies with a design guideline; and
extracting test data of a corresponding set of the character string and the label from the API specification information for each item of the design guideline and determining whether the test data complies with the design guideline by inputting the test data into the identification function.

5. The compliance determination method according to claim 4, further comprising correcting the API specification information determined as not complying with the design guideline to a specification complying with the design guideline using the identification function.

6. The compliance determination method according to claim 4, further comprising collecting a plurality of the application programming interface specifications complying with another design guideline having an item identical to each item of the design guideline from the outside through a network.
